(19) United States
(12) Patent Application Publication
(10) Pub. No.: US 2006/0185548 A1
(43) Pub. Date: Aug. 24, 2006

(54) Control method for production processes with colour-relevant products and print result control method

(75) Inventor: Joerg Peitzker, Herrath (DE)

Correspondence Address: Lipsitz & McAllister, LLC, 755 MAIN STREET, MONROE, CT, 06468, US

(73) Assignee: MEDIGRAPH GmbH, Hueckelhoven-Hilfarth (DE)

(21) Appl. No.: 11/356,469

(22) Filed: Feb. 15, 2006

Related U.S. Application Data
(63) Continuation of application No. PCT/EP04/06208, filed on Jun. 9, 2004.

(30) Foreign Application Priority Data
Aug. 19, 2003 (DE) 103 38 982.2
Sep. 2, 2003 (DE) 103 41 994.2

(51) Int. Cl. B41F 33/00

(52) U.S. Cl. 101/484

(57) ABSTRACT

Control method for production processes with colour-relevant products, wherein a production line with those stations in the production process, whose provision processes and/or processing processes influence the product outcome is defined, at least one master data record for each station in the production line is predetermined, and current data of a station with the associated at least one master data record are compared.

This application is a continuation of international application number PCT/EP2004/006208 filed on Jun. 9, 2004.

The present disclosure relates to the subject matter disclosed in international application number PCT/EP2004/006208 of Jun. 9, 2004 and German applications numbers 103 38 982.2 of Aug. 19, 2003 and 103 41 994.2 of Sep. 2, 2003 which are incorporated herein by reference in their entirety and for all purposes.

### BACKGROUND OF THE INVENTION

The invention relates to a control method for production processes with colour-relevant products and a print result control method.

Printing processes as an example of production processes with colour-relevant products comprise various stations such as proof, reproduction and print on printing machines, which are arranged in series. All stations are responsible for the print result with respect to print quality; if a station provides or allows through defective data or processes data incorrectly, then this can lead to a deterioration in the print result.

### SUMMARY OF THE INVENTION

In accordance with the invention, a control method for production processes with colour-relevant products and in particular a print result control method is provided, with which a production process can be monitored in a simple and reliable manner.

In accordance with the invention, a production line is defined with those stations in the production process, whose provision processes and/or processing processes influence the (colour-relevant) product outcome, at least one master data record is predetermined for each station in the production line and current data of a station are compared with the at least one associated master data record.

In accordance with the invention one or more master data records are predetermined as desired data record for each (relevant) station in the production line and current data are compared as actual data with the master data record or records, for example, at regular time intervals. In this way, drifts in the individual stations can be detected separately. The current data record is determined by current device parameters and in particular hardware parameters and/or software parameters of the devices in the respective stations. The devices can drift, i.e. the device parameters can vary in time. These drifts can in turn have effects on the preparation processes or processing processes of the respective station and thus also on the product outcome (such as the print result, for example). Changes in the device parameters with respect to calibration device parameters cause the actual data record (current data) to deviate from the desired data record (master data record). It is possible to determine whether devices need to be recalibrated, for example, by comparing current data with the master data separately for each station. It can be seen directly which station or stations are responsible for a deteriorating product outcome (such as a print end result, for example). The product outcome (such as a print result, for example) can be purposefully optimised by the control method in accordance with the invention, and through monitoring it can be ensured that the product outcome also meets the required quality standards over longer periods of time.

The production line need not necessarily be a real production line. It can also be a virtual production line, since it is definable by an operator.

The master data records are preferably device-neutral, if this is possible for a station, and are defined, for example, by a colour space standard such as the FOGRA standard. In particular, the master data records for “colour space-relevant” stations within a production line are identical: for example, the at least one master data record is identical for a proofing device and a printing machine.

The master data records are oriented to the result to be reached, the visual product image with respect to colour (such as a print layout, for example).

The production process (such as a printing process, for example) can be standardised in accordance with the invention. The responsibility of each station for the product outcome (such as the print result, for example) is highlighted, wherein each station can be checked separately and the production process (such as the printing process, for example) can be monitored or observed in its entirety.

In this case, it is provided in particular that calibrated devices of the corresponding station are used to determine or define device parameters leading to a master data record (“master device-parameters”). As a result, the master data record is produced on the basis of output parameters, which assure an optimum print result. (An optimum product outcome—such as a print result, for example, —is obtained if the current data record for each station is the master data record.)

It is provided that the comparison of current data occurs with the associated at least one master data record occurs at predetermined test intervals, wherein a time preset can occur at fixed intervals, for example. Current data are then generated, which are compared with the corresponding at least one master data record of the respective station. It can then be established whether there are any deviations within or outside a tolerance limit.

It is most particularly advantageous if a test data file is output to compare current data with the associated at least one master data record. This test data file is based on predetermined digital (test) data in particular, which are in turn determined by the current device parameters. In particular, the colour result is determined by the current device parameters.

If a check is to be conducted for measuring devices in a station or if measuring devices themselves define a station, then test measurements are advantageously conducted for such measuring devices to compare current data with the associated at least one master data record. By means of the test measurements (which are conducted in particular for predetermined data) it can then be determined whether there are any deviations relative to the master data record. With an orderly operation and setting of the measuring devices, the measurements on the predetermined data should give the at least one associated master data record.

If the test result is then measured for colour examination through spectrophotometric measurements, for example, then deviations between the master data record and the test data record can be determined.

In this case, it can also be provided that, in particular in association with a printing process and a proofing device, a white balance for the paper tone is conducted for the test result, so as to prevent corruption of the result on the basis of different paper tones.

It is most particularly advantageous if one or more test forms are predetermined for the test data file. These test forms are basically freely definable and serve to visualise the data. A colour chart or an image that can be freely predetermined can be selected as test form, for example. The test form is preferably selected so that the current data record can be compared in a simple and comprehensive manner with the at least one master data record. For example, colour tones in a test colour space can thus be compared in a simple manner with a reference colour space of the master data record.

In the comparison of current data with the associated at least one master data record, it is checked whether deviations lie within a predetermined tolerance. As a result of this, it can be established whether any action is required on a station, such as re-calibration of the corresponding devices of the station, for example, in order to improve the product outcome (such as a print result, for example). The method in accordance with the invention allows determination of the exact station at which the tolerance limit has been exceeded, i.e. that which has negatively influenced the product outcome (such as a print result, for example).

One or more measuring device stations can be provided, or for one or more measuring devices of a station a comparison can be conducted between current data and master data records with respect to the calibration. An example of such colour-relevant measuring devices is a spectrophotometer of a proof station in a printing process. If measuring devices deliver false or inexact data, then unsuitable data could possibly be allowed through and lead to an unsuitable product outcome. If measuring devices are monitored as stations of the production line itself or are also monitored within one station, then the product outcome can be purposefully monitored or improved through the monitoring.

A reproduction station is provided in particular, which generates a print layout, i.e. generates data, which can be processed by a printing machine. The reproduction station in this case comprises one or more raster image processors (RIP) and one or more illuminating devices to generate an exposed plate or an exposed film. RIPs and illuminating devices form one unit in particular. Alternatively, data for further processing can be generated through a digital printing machine.

A pre-stage station such as a prepress station can also be provided in a printing process, at which output data are preferably provided and/or displayed. The pre-stage station (such as a prepress station, for example) can comprise one or more proofing devices, at which a colour examination process is conducted with visual display of the data. If the data pass the colour examination process, then they can be passed to a reproduction station for further processing. In this sense, the pre-stage station (such as a prepress station, for example) prepares data. (If it is determined that the data do not meet the required standards, then there is no point in further processing the data for production of the end product such as the print, for example). A proofing device acts in association with the operator of the proofing device as a kind of firewall or filter: only data lying within the tolerances are allowed through for onward routing.

Moreover a colour production station (such as a printing machine station, for example) is provided, at which the actual colour-relevant production or processing process occurs (such as a printing process on the paper with the end result “printed paper”, for example).

In particular, a master data record for a station is based on device-independent definitions where this is possible. In principle, it is possible that a master data record contains device-dependent definitions. However, these are not readily comparable in the case of printing machines, for example. A purposefully and simple monitoring of the production process (such as a printing process) can be achieved via device-dependent definitions, wherein appropriate implementations for conducting the method and in particular software solutions can then also be used universally and in a scalable manner. Moreover, the colour reproduction can also be examined directly via device-dependent definitions. The colour reproduction substantially determines the product outcome (such as a print result).

In particular, a master data record is based on a colorimetric definition. The master data records for the pre-stage station (such as a prepress station) and for the colour production station (such as a printing machine station) are based on such a colorimetric definition, wherein the same definition (within certain tolerances) must be applied as basis. Therefore, it is provided that the master data record for the pre-stage station and for the colour production station is identical. However, the comparison with the current data occurs separately for these stations, since in the pre-stage station and in the colour production station the respective current data can deviate independently of one another from the associated at least one master data record. The at least one master data record is then a reference colour space (master colour space), which is compared with a current colour space. Then, the comparison can be conducted colour tone by colour tone with respect to deviations from the master data record. The colorimetry can be defined in particular in a device-independent manner via a LAB definition within certain tolerances.

Then, colour difference dimensions such as ΔE values are preferably determined to thus enable the quality of the current data record of the corresponding station to be examined in comparison to the at least one master data record.

Then, an actual (current) colour space and a predetermined reference colour space (master colour space) are compared. The reference colour space can meet a specific standard, such as a FOGRA standard, for example. Through the method in accordance with the invention it can be monitored whether this standard is met. Tools for conducting colour tone comparisons are known, such as the tool ColorLab of Gretag Macbeth or PrintOpen of Heidelberger Druckmaschinen AG. These can be incorporated into the method according to the invention. Through the method according to the invention these tools can then also be used via a network and also used for the production line (with a plurality of stations).

It can be provided that density and/or contrast and/or dotgain and/or grey balance and possibly further parameters are determined at the colour production station (such as a printing machine station). As a result, an operator or observer of the method according to the invention has the possibility of being able to monitor the actual printing process or also influence it accordingly. Since defined output data are worked from, namely the master data record, it can be purposefully suggested to an operator which parameters of a printing machine should be reset to correct a deviation from the master data record.

For example, an illumination calibration is calculated, which then ensures that a master data record is obtained on a colour production machine (such as a mixing machine or a printing machine). This illumination calibration determined in this manner then itself defines a master data record of the reproduction station. The illumination calibration is used for the calibration of illuminating devices and/or raster image processors, which provide layout data such as print layout data, which are then processed through a colour production machine such as a printing machine. Through appropriate adaptation of the calibration of such an illumination machine, a purposeful print gain (dot gain in the print) can be achieved on a printing machine. Therefore, this calibration is a means to achieve the aim of obtaining a product outcome coinciding with the associated master data record on the colour production machine.

Preferably, the master data record for the reproduction station is based on calibration data, which are determined so that for a given printing machine (with given print gain), for example, at least one master data record is generated (which meets a FOGRA standard, for example). In particular, the calibration data are adjusted externally. In contrast, the master data records for a proof station and a printing machine station are predetermined by the selected standard.

It is most particularly advantageous if a central apparatus or system is provided for comparison of the master data records with current data. In this case, the central apparatus can be arranged in a spatially decentralised location, and therefore the apparatus is a central apparatus, since it receives data from each station of the production line. Via the central apparatus it can be examined for each station whether the tolerance are adhered to. This in turn enables determination of which station is responsible for a deteriorating product outcome such as a print result, for example. Via the central apparatus an observer or operator of the production process (such as a printing process) can in turn observe the production process (such as a printing process) himself.

For example, as a result of this it can be monitored externally whether standardisations are adhered to. It is also fundamentally possible that the corresponding devices of the stations can be controlled via the central apparatus. If, for example, it is determined for a proofing device that the actual data deviate too heavily from the master data, then the central system can cause a re-calibration of the proofing device or transmit modified ICC profiles to the proofing device, which take into consideration the actual state of the proofing device. Defined user rights can also be allocated for such a central system, so that it can be defined who may conduct what monitoring processes and possibly who may conduct what control processes.

Device parameters of the devices of the respective stations are preferably supplied to the central apparatus, so that the central apparatus can directly detect a device drift, for example.

In particular, the master data records are stored in the central apparatus so that a comparison with the current data can be conducted.

Current data and/or device parameters of the stations are supplied to the central system to enable the comparison to be conducted.

It is most particularly advantageous if the central apparatus is connected to the stations via a network such as the internet or an internal network or the like, i.e. the central apparatus can be reached through the network for these stations. The central apparatus can then be arranged spatially separately from the stations. The production process (such as a printing process) can then also be monitored if the stations of the production line are arranged at different spatial locations. The central apparatus can be configured, for example, as a software solution on a server.

It is then additionally favourable if the central apparatus can be accessed via a network, so that one or more participants in the production process (such as a printing process, for example), such as a customer or an operator, for example, can monitor or observe the production process.

In particular the central apparatus predetermines test time intervals for checking the current data and/or device parameters. It is then ensured that the central apparatus, preferably regularly, receives current data and/or device parameters, so that it can be checked whether no longer tolerable deviations are preset with respect to the at least one master data record, and this in turn necessitates a re-calibration of the corresponding devices of the stations responsible for the deviations. Such a re-calibration can also occur automatically. The central apparatus can implement a re-calibration if excessive deviations are established. The central apparatus can then conduct a remote calibration if the devices are provided with appropriate interfaces. For example, a new ICC profile can also be predetermined for a proofing device, which is selected so that with the current device parameters (which differ from the master device parameters) a current data record coinciding with the at least one master data record is generated.

The method in accordance with the invention can be conducted automatically. In particular the comparison between the current data and the master data records can be conducted automatically. Moreover, the data acquisition can be conducted automatically.

It is possible that a master data record comprises tolerance data, which define the allowed tolerances. If a current data record contains data, which are identical to the master data, or contains data, which lie within a tolerance range of the master data, then no intervention is necessary, or a product outcome with the desired quality is to be expected. By including the tolerance data into a master data record, the special conditions of each station of the production line can be determined and no further data need to be added for evaluation of the comparison of current data with a master data record, since the tolerance limits are contained in the master data record.

It can also be provided that a comparison of current data is conducted with at least two master data records. Thus, it is possible, for example, that current data are compared with an externally predetermined standardisation master data record and additionally also compared with an internally predetermined master data record. The comparison with an external reference (standardisation master data record) and an internal reference (internal master data record) enables an optimisation to be achieved within a production line taking into account the internal conditions. The provision of a plurality of master data records in one station also enables a cross-comparison, via which the check can be improved or optimised and/or via which additional information can be acquired.

The control method for production processes with colour-relevant products in accordance with the invention may be converted into a software solution. In accordance with the invention, a computer program product with at least one computer-readable medium and a computer program stored on the at least one computer-readable medium with program coding means can be provided, wherein the program coding means is suitable for conducting a method in accordance with the invention during running of the computer program. In this case, the computer program can run on several computers, e.g. on a central apparatus or system and on computers of the stations.

A computer program with program coding means, which are suitable for conducting a method in accordance with the invention on one or more computers during running of the computer program, can also be provided.

The following description of preferred embodiments serves to explain the invention in more detail in association with the drawing.

### BRIEF DESCRIPTION OF THE DRAWING

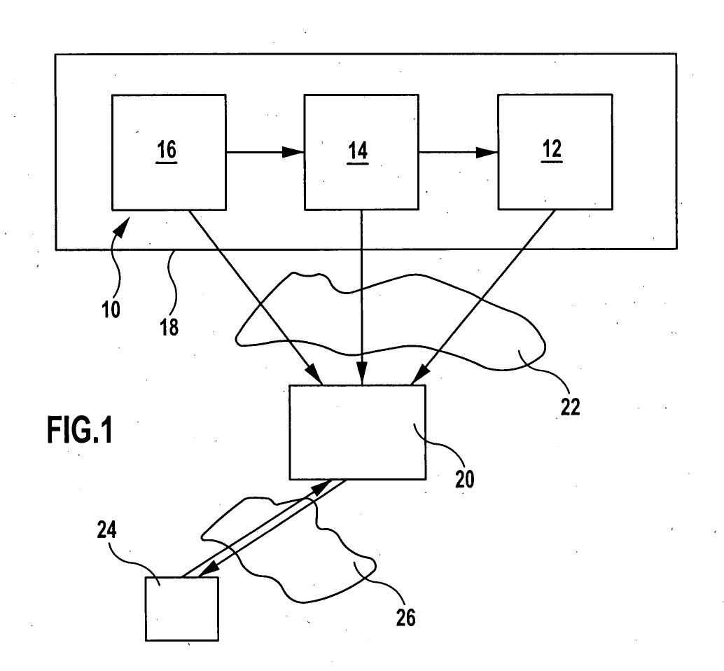

The single FIG. 1 schematically shows an example of a production line for a printing process, in which the method according to the invention is conducted.

### DETAILED DESCRIPTION OF THE INVENTION

Practical examples of the control method for production processes with colour-relevant products in accordance with the invention are explained below using the example of a print result control method. The colour-relevant products are then print results in this case, i.e. printed brochures or books, for example. The production process is then a printing process.

A printing process, in particular for printing paper, comprises various stations arranged consecutively in series, which are given the reference 10 in FIG. 1. Each station 10 prepares data, in particular in the sense that it “approves” data or processes data, which are required by subsequent stations. These preparation processes and processing processes can have an effect on the print result and in particular the printing quality.

The last station in a printing process is a printing machine station 12. This comprises one or more printing machines, which print paper, for example, or other printable flat material.

The printing machine station 12 is usually arranged before a reproduction station 14 (repro station), in which a layout of printing data for the printing machines of the printing machine station 12 is created. In particular, the reproduction station 14 comprises raster image processors (RIP) and an exposure station, which creates exposed plates (CtP—computer to plate) or films (CtF—computer to film) for offset printing. Alternatively data, which can be processed through a digital printer, can be created.

One or more prepress stations 16 can be optionally connected in front of the reproduction station 14. Such prepress stations 16 comprise in particular one or more proof stations, in which a colour testing process is conducted for the colour reproduction. In an ideal case, only data, which have previously been released in the pre-print state station or stations 16, should be supplied to the reproduction station 14. The release is performed by an operator, for example.

It is basically also possible that data are modified in a prepress station 16 in such a manner that they have the necessary properties. For this, the prepress station 16 can comprise a modification station. An observer of the result of the proofing device modifies the data within a predetermined standard such as the FOGRA standard to improve the subjective colour sensation. For example, data are modified so that a natural colour sensation results for the faces of people. The modified data are then in turn subjected to a colour test process and on “approval” are prepared by the operator, i.e. authorised for further processing in the reproduction station 14.

A prepress station prepares data in the sense that it allows unsuitable data to be detected, which can then be excluded from further processing.

The prepress stations 16 can be situated completely or partially externally of a printing plant. It is also possible for the reproduction station 14 to be situated externally of a printing plant.

Each of the stations 12, 14, 16 has devices, which have specific setting capabilities with respect to hardware and/or software. The printing machine station 12 comprises one or more printing machines. The reproduction station 14 comprises one or more illuminating devices with raster image processors connected in front of them. The prepress station 16 comprises one or more proofing devices. The settings of these devices can have a drift with respect to hardware and/or software. This drift can in turn have a negative effect on the print quality and lead to colour corruptions, for example.

Hitherto it has been difficult to attribute a print result of poor quality to a specific station 10. This problem is solved with the print result control method according to the invention.

For this a production line 18 (colour line) is defined, which comprises those stations 10, whose provision processes and/or processing processes influence the print result and in particular decisively influence this. In the example shown in FIG. 1, the production line 18 comprises a proof station 16, a reproduction station 14 with one or more illuminating devices and a printing machine station 12.

For each station 10 at least one master data record is predetermined as a desired data record, which is selected so that, if the current data record of each station 10 corresponds to the associated at least one master data record, i.e. is the same as this or lies within the predetermined tolerances, a print result of the required quality results. In this case, the tolerances are contained in particular in the master data record, i.e. this contains tolerance data, which define the permissible deviations. Specific device parameters form the basis of the current data records of the individual stations 10. In the case of calibrated devices the current data record must correspond to the master data record within the predetermined tolerances.

The master data records of each station 10 are stored in a central apparatus 20. In this case, the central apparatus 20 can be arranged in a decentralised location with respect to the production line 18 or individual stations 10 of the production line 18. In particular it is provided that the stations 10 communicate with the central apparatus 20 via a network (which is indicated with the reference 22 in FIG. 1). The network 22 can be the internet or an intranet, for example.

If the master data records have been predetermined for the stations 10 (i.e. have been defined or the associated device parameters have been determined), then they are transmitted via the network 22 to the central apparatus 20 and stored there. The central apparatus 20 is configured on a server, for example.

The central apparatus 20 predetermines regular test intervals for each station 10, for example, to be able to check the settings of the individual stations 10. A current data record is then generated with the current settings of the corresponding stations 10. This current data record (actual data record), which is based on the current actual settings (device parameters) with respect to hardware and/or software of the corresponding devices of the respective station 10, is then compared with the master data record (desired data record). Deviations between the actual current data record and the master date record can then be determined for each station 10. In particular, the comparison is conducted automatically in the central apparatus 20.

The central apparatus 20 can then determine whether a correction of the settings of the devices of a checked station 10 is necessary, i.e. whether a re-calibration is necessary. This process is conducted separately for each station 10, e.g. station 12, 14 and 16, to be able to detect and if necessary correct deviations from the master data record at each station 10.

If the print result has a reduced quality overall, then it can be determined directly through this comparison which station 10 or which stations 10 are responsible for it. The comparison data would be indicated directly to the person responsible for station 10, e.g. through an electronic message. They can also be indicated to the person responsible for the production line overall or to the customer (who is interested above all in the print result).

There can be direct intervention in the corresponding station if too great a deviation has been determined between the current data record and the master data record. Wastage is thus kept at a low level.

Device parameters and the like for the individual stations 10 can also be supplied to the central apparatus 20, so that the central apparatus 20 has an overview of the settings of the entire production line 18. If a drift of device parameters is detected, then a correction can be implemented, e.g. by re-calibration of the corresponding device. If the device has an interface to the central system, this correction can also occur automatically.

A “customer” 24 of the central apparatus 20 can monitor or observe the production line 18 through access to the central system and in particular can monitor this for deviations with respect to the master data record.

The customer 24 can access the central apparatus 20 in particular via a network 26 such as the internet.

The customer 24 can be a customer of a printing office, for example, who thus has the opportunity to conduct a quality control with respect to the printing process. For example, the customer can also be an operator of the printing office, who can thus perform a quality assessment on the production line 18 and if necessary intervene therein.

Since the central apparatus 20 can also be arranged in a decentralised location, monitoring of the printing process can be conducted, in principle, from any location in the world. This monitoring is independent of whether the individual stations 10 are spatially adjacent or are arranged at different locations. This allows printing assignments to be completed in a standardised manner throughout the world.

Each individual station 10 of the production line 18 has a clear indication of its own responsibility for the print result via the monitoring of the central apparatus 20.

The current data record, which is prepared by each station 10 (or displayed in the case of a proofing device), is determined by the respective parameters and in particular device parameters (with respect to hardware and/or software) of the respective station 10. The master data record is preferably selected to be device-independent, where this is possible.

In principle, the device parameters could themselves be selected as data for the master data record. In the case of the reproduction station 14 the master data record is selected so that printing may occur in accordance with a predetermined master data record on a printing machine. However, for proofing devices (prepress station 16) and printing machines (printing machine station 12) it is preferred to build on device-independent presets and in particular on colour space data such as LAB data. The master data record then comprises colour space data, which are based on a specific standard such as the FOGRA standard. In particular, the prepress station 16 and the printing machine station 12 have the same master data record.

The test data for these stations are then colour space data, wherein the current colour space is compared with a reference colour space (predetermined by the master data record). Deviations between the colour space according to the master data record and the current data are expressed via a colour difference dimension, e.g. the colour difference ΔE (see, for example, H. Eschner, Offsetdrucktechnik [Offset printing technology], Fachschriften-Verlag, 10th edition, 1997).

On the basis of such a colour difference dimension ΔE, it can be determined for each colour tone whether the tolerance values are adhered to for the prepress station 16 and for the printing machine station 12.

For example, in offset printing, values for ΔE less than or equal to 1.5 with respect to full tones and ΔE less than 2.0 for grey tones are assessed as invisible, while values of ΔE of 2.5 or more for full tones and of 5.0 to 7.0 for grey tones are assessed as visible.

For the respective stations the test data are preferably generated on the basis of fundamentally freely definable test forms, which are predetermined. Individual test forms can be selected, which are selected, for example, from the viewpoint of simple comparability between the master data record and the current data. For example, test forms, which are based on test charts such as ECI2002_Visual, ECI2002_Random, IT873_Visual or IR873_Random, are used for a proof station or the printing machine station 12.

It is also possible to select (colour) images, which in particular can be freely predetermined. For example, it is possible to switch back and forth between master data and current data on the colour image and in particular switch back and forth on image areas that can be predetermined to enable colour differences to be detected. Thus, the face colour of a person shown in the colour image test form, for example, can be compared between master data and actual data.

In particular it can be examined whether the current data adhere to a predetermined standard such as a FOGRA standard, for example.

From the current data of the printing machine station 12 in association with the known exposure calibration, the central apparatus 20 can also determine parameters of the printing such as in particular the density in the print and/or contrast in the print and/or dotgain curves and/or grey balances.

It is also possible, on the basis of these data of the printing machine station 12, to calculate calibration data for illuminating devices , with which, for example, a specific pressure increase can be set for a printing machine. This exposure calibration function, which is fundamentally variable, can then be used for calibrating illuminating devices in the reproduction station 14. The master data records for a proof station and a printing machine station are not variable, if they are based on colour space definition and are to meet the FOGRA standard, for example.

Through the method according to the invention all the relevant stations 10 of the production line 18 (colour line) can be monitored transparently for all participants, such as an agency as customer or the operator of the printing office, for example. Adherence to a quality standard can also be checked in real time, if necessary. Through the management of calibration actions and configurations by the central system, defined states for the production line 10 can be set and archived.

In the case of a poor print result it can be checked directly which station 10 is responsible for it.

The central apparatus 20 takes over the administration tasks for the freely definable production line 18.

Since the production 18 is definable with its individual stations, the method according to the invention can be used in a scalable manner for any desired printing processes.

In the case of deviations an operator can be purposefully provided with assistance, as to which device parameters are to be amended and how in order to bring the current data into agreement with the corresponding master data record. The analysis results of the central apparatus 20 are preferably displayed so that targeted suggestions are made to the operator.

It is fundamentally possible that more than one master data record is predetermined for a station of the production line 18. This then enables a comparison of current data for each station with several master data records associated with the station. It is possible in this case that a different number of master data records is defined for each station.

For example, it is thus possible to compare the current data with an external reference and an internal reference. A standardisation master data record, for example, is then used as external reference and an internal master data record as internal reference. In this way, the internal conditions of the production line 18 or a part of the production line 18 can be taken into consideration. For example, it is thus possible to introduce in the printing office the print image that is possible on the basis of the given equipment as internal reference.

It is also possible that a master data record comprises tolerance data, which define which deviations of the current data from the data of the master data record are allowed. The master data record then supplies the tolerance thresholds, which in the case of a comparison process with current data determine whether the deviation from the master data is still allowed or no longer tolerable.

One of more measuring devices can be arranged in the production line 18. For example, stations comprise measuring devices. It is also possible that one or more measuring devices are defined as their own station.

Master data records, which comprise specific settings of the measuring devices and/or calibration data, for example, are generated for the measuring device or devices. Through comparison with current data it can then be determined whether setting parameters and/or calibration data have changed. A change can mean that the measured result of the measuring device is no longer reliable.

The method in accordance with the invention also allows the measuring devices to monitor themselves. As a result of this, it is assured, for example, that a proof result is not corrupted by measuring device errors.

The control method for production processes with colour-relevant products according to the invention can also be used in other production processes with colour-relevant products. Possible fields of application are, for example, production processes for wallpapers, wall colours, paints such as automotive paints, casings etc. What these processes have in common is that the end product is a colour-relevant product, i.e. the colour of the end product or the colours on the end product must be precisely defined and the colour sensation must be reproducible. For example, it is not permissible in the production of wall colours for deviations in colour tone that are visible to the eye to occur in the case of a special wall colour. In the production of automotive paints, it is also very important, for example, that the end product must be reproducibly produced. Thus, it can also be ensured that a paint can be produced with a specific colour tone, via which damages to paint can be retouched, for example.

In this case, the production line is defined differently, depending on the field of application, namely via those stations in the production process, whose preparation processes and/or processing processes influence the product outcome (with respect to the colours). A master data record is predetermined for each of these stations and a comparison of current data of one station with the associated master data record is conducted.

1. Control method for production processes with colour-relevant products, comprising:
defining a production line with those stations in the production process, whose provision processes and/or processing processes influence the product outcome;
predetermining at least one master data record for each station in the production line, and
comparing current data of a station with the associated at least one master data record.

2. Control method according to claim 1, wherein calibrated devices of the corresponding station are used to determine or define device parameters of a station which lead to a master data record.

3. Control method according to claim 1, wherein the comparison of current data with the associated at least one master data record occurs at predetermined test intervals.

4. Control method according to claim 1, wherein a test data file is output to compare current data with the associated at least one master data record.

5. Control method according to claim 1, wherein test measurements are conducted for measuring devices to compare current data with the associated at least one master data record.

6. Control method according to claim 4, wherein the test result is measured.

7. Control method according to claim 4, wherein one or more test forms are predetermined for the test data file.

8. Control method according to claim 1, wherein in the comparison of current data with the associated at least one master data record it is checked whether deviations lie within a predetermined tolerance.

9. Control method according to claim 1, wherein one or more measuring device stations are provided, or for one or more measuring devices of a station a comparison is conducted between current data and master data records with respect to the calibration.

10. Control method according to claim 1, wherein a reproduction station is provided.

11. Control method according to claim 1, wherein at least one pre-stage station is provided.

12. Control method according to claim 1, wherein a colour production station is provided.

13. Control method according to claim 1, wherein a master data record for a station is based on device-independent definitions.

14. Control method according to claim 1, wherein a master data record is based on a colorimetric definition.

15. Control method according to claim 14, wherein master data records for a pre-stage station and for a colour production station are identical.

16. Control method according to claim 14, wherein colour difference dimensions are determined.

17. Control method according to claim 14, wherein ΔE values are determined.

18. Control method according to claim 14, wherein an actual colour space and a reference colour space are compared.

19. Control method according to claim 12, wherein at least one of density, ocontrast, and grey balance are determined.

20. Control method according to claim 10, wherein an illumination calibration is calculated, which ensures that at least one master data record results in a colour production station.

21. Control method according to claim 10, wherein the at least one master data record is adjusted for the reproduction station.

22. Control method according to claim 1, wherein a central apparatus is provided for the comparison of the master data records with current data.

23. Control method according to claim 22, wherein at least one of the master data records and device parameters are stored in the central apparatus.

24. Control method according to claim 22, wherein at least one of current data and device parameters of the stations are supplied to the central apparatus.

25. Control method according to claim 22, wherein the central apparatus is connected to the stations via a network.

26. Control method according to claim 22, wherein the central apparatus is accessible via a network.

27. Control method according to claim 22, wherein the central apparatus predetermines test intervals for checking the current data.

28. Control method according to claim 1, characterised by an automated implementation.

29. Control method according to claim 1, wherein the control method is a print result control method and the colour-relevant product outcome is a print result.

30. Control method according to claim 1, wherein a master data record comprises tolerance data, which define the allowed tolerances.

31. Control method according to claim 1, wherein a comparison of current data with at least two master data records is conducted.

32. Print result control method for production processes with colour-relevant products, comprising:
defining a production line with those stations in the printing process, whose provision processes and/or processing processes influence the print result;
predetermining at least one master data record for each station in the production line, and
comparing current data of a station with the associated at least one master data record.

33. Print result control method according to claim 32, wherein a test data file is output to compare current data with the associated at least one master data record.

34. Print result control method according to claim 33, wherein a white balance for the paper tone is conducted for the test result.

35. Print result control method according to claim 32, wherein a printing machine station is provided.

36. Print result control method according to claim 32, wherein master data records for a prepress station and for a printing machine station are identical.

37. Computer program product with at least one computer-readable medium and a computer program stored on the at least one computer-readable medium with program coding means, which are suitable for conducting a control method for production processes with colour-relevant products, during running of the computer program on one or more computers, said central method comprising:
defining a production line with those stations in the production process, whose provision processes and/or processing processes influence the product outcome;
predetermining at least one master data record for each station in the production line, and
comparing current data of a station with the associated at least one master data record.

38. Computer program with program coding means, which are suitable for conducting a control method for production processes with colour-relevant procucts, during running of the computer program on one or more computers, said control method comprising:
defining a production line with those stations in the production process, whose provision processes and/or processing processes influence the product outcome;
predetermining at least one master data record for each station in the production line, and
comparing current data of a station with the associated at least one master data record.
